(19) United States
(12) Patent Application Publication
(10) Pub. No.: US 2011/0127323 A1
(43) Pub. Date: Jun. 2, 2011

(54) METHOD AND APPARATUS FOR TRANSPORTING ARTICLES USING MOBILE DATA MEMORIES

(75) Inventors: GISBERT BERGER, BERLIN (DE); PETER BRETSCHNEIDER, BIRKENWERDER (DE); SVETLOZAR DELIANSKI, BERLIN (DE); ANDREJ DRONNIK, BERLIN (DE)

(73) Assignee: SIEMENS AKTIENGESELLSCHAFT, MUENCHEN (DE)

(21) Appl. No.: 12/957,860

(22) Filed: Dec. 1, 2010

(30) Foreign Application Priority Data
Dec. 1, 2009 (DE) 10 2009 056 422.5

(51) Int. Cl. G06Q 90/00; G06Q 10/00

(52) U.S. Cl. 235/375

(57) ABSTRACT

A method and an apparatus for transporting a plurality of articles, particularly, mail items. For each article a measurement is taken regarding what value a prescribed feature and what value a prescribed transportation attribute assume for the article. A data record for this article with the measured transportation attribute value and the measured feature value is produced. This data record is stored in a mobile data memory of a means of a transport. The articles are put into the means of transport and transported in the means of transport to an intermediate point. Following this transportation, for each article another measurement is taken regarding what value the feature assumes for this article. The mobile data memory is searched for that data record for the article for which the feature value ascertained during the fresh measurement is used. Further transportation of the article is initiated on the basis of the transportation attribute value of the ascertained data record.

### CROSS-REFERENCE TO RELATED APPLICATION

This application claims the priority, under 35 U.S.C. §119, of German patent application DE 10 2009 056 422.5, filed Dec. 1, 2009; the prior application is herewith incorporated by reference in its entirety.

### BACKGROUND OF THE INVENTION

### Field of the Invention

The invention relates to a method and an apparatus for transporting articles, particularly flat mail items, using a mobile data memory.

In order to transport an article to a prescribed destination, transportation attributes are required. Examples of transportation attributes are identification for the destination and also the weight and dimensions of the article. The measurement regarding what value a transportation attribute assumes for an article to be transported may be linked to considerable complexity, for example because a statement relating to the destination cannot be read automatically and needs to be deciphered and then input by a human. The transportation attribute is therefore measured once, and the measured transportation attribute value is used again later.

One option which has been used for a long time is that of printing the measured transportation attribute value onto the article itself or attaching it in another way. By way of example, encoding for the delivery address which has been read is printed onto a mail item in the form of a bar code or a matrix code.

A further option is that of placing a machine-readable identifier onto the article and creating a data record with that identifier and the transportation attribute value in a central database. In order to use the transportation attribute value again, the identifier is read, and the central database is searched for the data record with the identifier.

In order to avoid having to provide an article with an identifier, “fingerprint” methods (“Virtual ID”) have been proposed. Commonly assigned U.S. Pat. No. 6,888,084 B1 and its counterpart European patent EP 1 222 037 B1 discloses the practice of producing a feature value vector with pictorial features of the article, for which a depiction of the article is produced. A data record for the article comprises the feature value vector and the transportation attribute value. In order to acquire the transportation attribute value again, the article is measured again.

A method and an apparatus having the basic features are described in the commonly assigned U.S. Pat. No. 7,810,712 B2 and its counterpart German applications DE 102007057985 A1 and DE 102008017186 A1. These documents are incorporated by reference.

The methods described therein provide a solution for the problem, which arises with fingerprint, namely that the search for the data record for an article requires the feature value vector of the article to be compared with a very large number of feature value vectors for stored data records. It is therefore proposed that a means of transport which is used to transport articles be provided with a tag. In the exemplary embodiment, flat mail items are transported in containers. This tag comprises a machine-readable identification for the means of transport. A central database is used to store the transportation information item regarding which article is being transported in which means of transport. This transportation information item is used in order to restrict the search space to be searched during the search for the data record.

Patent application publication US 2002/012045 A1 describes a method for the transportation of a transportation container (“carrier 30”). The transportation container 30 contains a plurality of articles (“individual containers 40A through 40N”). The transportation container 30 has a data memory (“memory 60”). Each article 40A to 40N has its own respective data memory (“memory devices 50A through 50N”). The data memory 50x of an article 40x stores an explicit identifier, the destination address, transportation requirements (temperature, humidity), details relating to the sender and recipient and a desired latest time of arrival, inter alia. These data are generated by a central server 90.

DE 10 2004 037 365 A1 describes a container which is used for transporting articles or can be used for this purpose, e.g. in order to transport mail items. The container comprises a multiple write electronic tag with a display panel. This display panel can be used to show information in a form which can be read by a human. By way of example, information about the content of the container or about a sorting or handling station is displayed. The container needs to be transported to this sorting station, for example.

### SUMMARY OF THE INVENTION

It is accordingly an object of the invention to provide a method and device for transporting articles using mobile data memories which overcome the above-mentioned disadvantages of the heretofore-known devices and methods of this general type and which provides for an improved method and an improved apparatus which allow transportation of the article without the need for read access to a central database with the data records.

In other words, one of the objects of the invention is to improve a method for transporting articles, wherein at least one measurable transportation attribute and at least one measurable feature are prescribed, and wherein the method comprises the steps that for each article:

a measurement is taken regarding what value the feature assumes for this article;

a measurement is taken regarding what value the transportation attribute assumes for this article; and

a data record for the article is produced and stored, the data record comprising the at least one measured transportation attribute value and the at least one measured feature value;

the articles are placed into at least one means of transport and are transported to an intermediate point using this at least one means of transport;

for each article, following transportation to the intermediate point, another measurement is taken regarding what value the feature assumes for this article, the at least one feature value measured during the fresh measurement is used to ascertain the data record produced and stored for this article, and further transportation of the article is initiated on the basis of that transportation attribute value which is contained in the ascertained data record.

Another object of the invention is to improve an apparatus for the transportation of articles, which apparatus comprises a first measuring instrument, a second measuring instrument, an attribute measuring instrument, at least one means of transport, a first data processing device, and a second data processing device. The first measuring instrument is designed to measure, for each article, a respective value which at least one prescribed feature assumes for this article, the attribute measuring instrument is designed to measure, for each article, what value at least one prescribed transportation attribute assumes for this article, and the first data processing device is designed to produce and store, for each article, a respective data record. The data record includes the at least one measured transportation attribute value and the at least one measured feature value. Each of the transport means is designed to have the articles put into the means of transport and to have them transported in the at least one means of transport to an intermediate point. The second measuring instrument is designed to measure again, for each article, a respective value which the prescribed feature assumes for this article. The second measuring instrument is arranged such that it measures the value following transportation of the article to the intermediate point. The second data processing device is configured to use the feature value measured during the fresh measurement to ascertain the data record produced and stored for this article, and the second data processing device is configured to initiate further transportation of each article on the basis of the transportation attribute value thereof which is contained in the ascertained data record.

With the foregoing and other objects in view there is provided, in accordance with the invention, a method for transporting articles, wherein at least one measurable transportation attribute and at least one measurable feature are prescribed, and the method comprises:

for each article,

taking a measurement to ascertain what value the measurable feature assumes for the respective article;

taking a measurement to ascertain what value the measurable transportation attribute assumes for the respective article; and

producing and storing a data record for the article, the data record containing:
the at least one measured transportation attribute value; and
the at least one measured feature value;

providing a means of transport with a data memory to be transported together with the means of transport,

placing the article into the means of transport and transporting the article to an intermediate point with the at least one means of transport and the data memory, wherein the respective data record for the article is stored in the data memory; and

following transportation to the intermediate point, for each article which is transported using the means of transport:

taking a further measurement to ascertain what value the feature assumes for the article;

ascertaining the data record for the respective article from the data records stored in the data memory of the means of transport; and

initiating further transportation of the article based on the transportation attribute value contained in the data record thus ascertained.

In other words, according to the invention, at least one measurable transportation attribute and at least one measurable feature are prescribed. At least one means of transport is used for the transportation of the plurality of articles. This at least one means of transport has a mobile data memory which is transported together with the means of transport.

For each article, the following steps are performed:

A measurement is taken regarding what respective value the or each prescribed feature assumes for this article. A measurement is taken regarding what respective value the or each prescribed transportation attribute assumes for this article. A data record for the article is produced and stored. This data record comprises each transportation attribute value measured for the article and each feature value measured for the article. This data record is stored in the mobile data memory of the means of transport. The article is placed into the at least one means of transport and transported to an intermediate point using the means of transport.

Following the transportation of the articles to the intermediate point, the following steps are performed for each article: Another measurement is taken regarding what value the or each prescribed feature assumes for the article. The data record produced and stored for this article is sought among those data records which are stored in the mobile data memory of the means of transport. For the search, the at least one feature value which was measured during the fresh measurement is prescribed. The respective transportation attribute value which is contained in the ascertained data record is taken as a basis for initiating further transportation of the article.

The invention dispenses with the need to provide each article with an explicit identifier. On the contrary, the article is identified by means of the feature value(s) obtained during the fresh (i.e., further) measurement.

This is advantageous for the following reasons: Normally, the same means of transport is used to transport a plurality of articles at once. If one mobile data memory is used per means of transport, fewer data memories are needed than in the case of one data memory per transported article.

The same means of transport can normally be used for a plurality of successively performed transportation operations, with each transportation operation respectively involving the transportation of at least one article. It is therefore also possible to use the mobile data memory again. If, by contrast, a respective data memory were used per transported article, this data memory would normally no longer be available after the conclusion of the transportation.

The invention dispenses with the need to provide the means of transport with an identifier for the means of transport and to read this identifier later. In addition, the invention means that it is not necessary to provide the article itself with a data memory or to provide a respective data memory per article.

It is also not necessary to provide the article with a machine-readable identifier or to print the transportation attribute value onto the article itself. This saves ink for printing and tags, which saves time and cost and avoids burdening the environment.

The method based on the solution and the apparatus based on the solution obviate the need to set up read access to a central data memory in order to ascertain the stored transportation attribute value for an article. Such read access may not be possible at all at times on account of disconnection or failure of a server, or may require considerable execution time on account of a high volume of data. On the contrary, the at least one feature value and the at least one transportation attribute value are stored in a mobile data memory which is connected to the means of transport and is transported with said means of transport.

The method according to the invention and the apparatus according to the invention can easily be integrated into an existing sorting installation which performs finger printing. The additionally required equipment complexity is low.

The data in the data memory of the means of transport can easily be updated and corrected when needed.

The mobile data memory on the means of transport does not necessarily need to have a display panel in order to display information in a form which can be read by a human. The mobile data memory can be implemented completely without a display panel. The data records which are stored in the mobile data memory each relate to an article in the means of transport. The data records can be evaluated fully automatically without the need for a human to read information on a display panel. In order to store the data records, less power and less time are required than if information needed to be written to a display panel in a form which can be read by a human. It is possible, but not necessary, to additionally store information about the means of transport as a whole, e.g. about a transportation destination.

It is possible to use the data stored in the data memory of the means of transport additionally as an operating protocol in order to later ascertain which articles are transported in this means of transport. In addition to these stored data, it is possible to store time stamps, for example the time at which the means of transport reaches or leaves an intermediate point during transportation.

The invention allows a better check on what articles are in the means of transport. The data records in the mobile data memory can be compared with the articles which are actually in the means of transport without the need for an identifier for each article. This makes subsequent manipulations more difficult.

Preferably, the feature value and the transportation attribute value of each article are measured before the article is put into the means of transport. It is then possible to take the measurements more easily than at a later time. The step of putting the articles into the means of transport initiates the step of storing the data records for these articles in the data memory of the means of transport.

This dispenses with the need to store these data records outside of the data memory and to keep them available, which requires synchronization with other data and operations. In addition, it reduces the risk of incorrect data records being stored in the data memory, that is to say data records from articles which are not in the means of transport, or else of data records being missing, that is to say of no data record being stored for an article in the means of transport.

Preferably, both the measurement and the fresh measurement involve a feature value vector being produced. This feature value vector distinguishes the article from the other transported articles. This dispenses with the need to provide the article with an explicit identifier or to find a single visually detectable feature, the values of which distinguish the articles from one another. Apart from an explicit identifier, there is normally no such explicitly identifying feature.

In one refinement, at least one means of transport with a data memory and a further means of transport without a data memory are used. This refinement avoids the need to provide all the means of transport used with mobile data memories at one stroke.

This refinement involves an automatic check to determine whether or not a means of transport which is used to transport articles has a data memory. If the means of transport does have a data memory, the data records for the articles which are transported in this means of transport are stored in said data memory of the means of transport. Otherwise, the data records are stored in a central immovable data memory.

It is also possible for data records for the same articles to be stored both in a data memory of a means of transport and in the central data memory. This refinement allows a check on the search result for the search among the data records in the mobile data memory on the means of the transport and, by way of example, correct results to be obtained even if articles have subsequently been removed from or added to the means of transport.

Other features which are considered as characteristic for the invention are set forth in the appended claims.

Although the invention is illustrated and described herein as embodied in a method and apparatus for transporting articles using mobile data memories, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 schematically shows an arrangement for carrying out the method, wherein each container has a mobile data memory; and

FIG. 2 shows a variation of the configuration of FIG. 1, wherein a central database is additionally used.

### DETAILED DESCRIPTION OF THE INVENTION

In the exemplary embodiment, the articles to be transported are mail items, for example letters, postcards, catalogs or else packages. Each mail item is provided with details relating to that delivery address to which said mail item needs to be transported. These delivery address details act as the destination for the mail item. The details have normally been put onto the mail item prior to the beginning of transportation. However, it is also possible for them to be put on only during transportation.

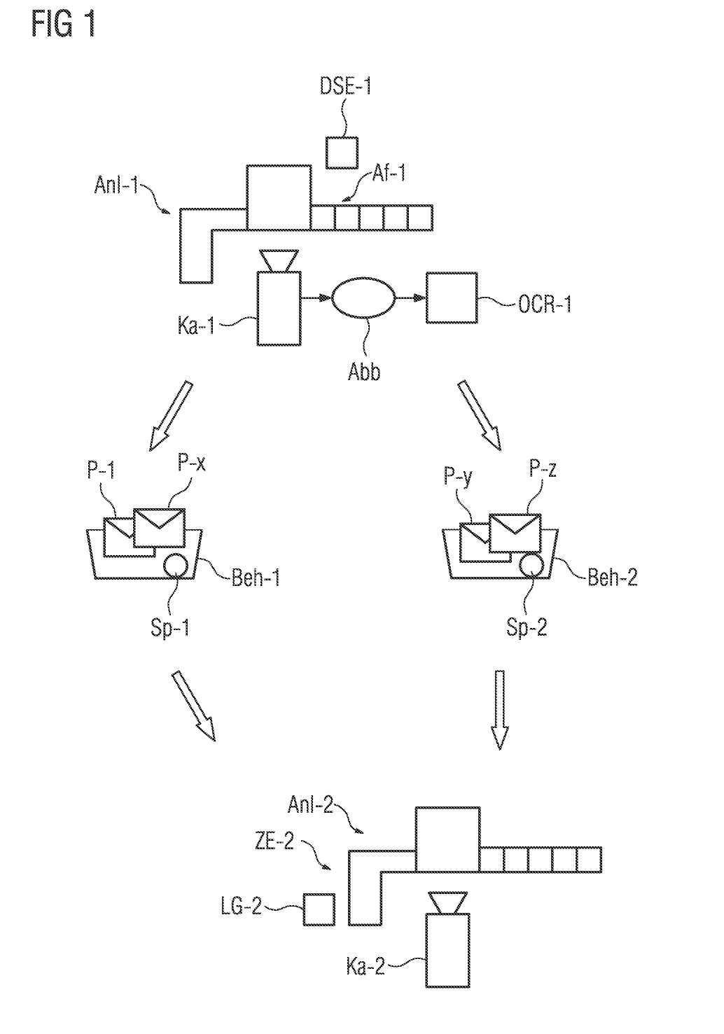

Referring now to the figures of the drawing in detail and first, particularly, to FIG. 1 thereof, there is shown an arrangement for carrying out the method with two sorting installations Anl-1 and Anl-2. The first sorting installation Anl-1 has an output compartment Af-1, a first camera Ka-1, an OCR unit OCR-1, a first evaluation unit Aus-1 and a data memory DSE-1. The second sorting installation Anl-2 has a supply device ZE-2, a second camera Ka-2, a second evaluation unit Aus-2 and a reader LG-2.

In FIG. 1, material flows are shown by way of solid lines and data flows are shown by way of dashed lines.

Each mail item passes through a sorting installation at least twice. It is possible for a mail item to pass through the same sorting installation a plurality of times or to pass through a sorting installation three times. The sorting installation used for the first pass is the first sorting installation Anl-1, and the sorting installation used for the second pass is the second sorting installation Anl-2 or a third sorting installation.

In the example in FIG. 1, the z mail items P-1, . . . , P-x, P-y, . . . , P-z pass through the first sorting installation Anl-1. Next, the first x mail items P-1, . . . , P-x pass through the second sorting installation Anl-2, and the remaining mail items pass through a further sorting installation—not shown.

The first camera Ka-1 in the first sorting installation Anl-1 produces a respective computer-accessible depiction Abb of each mail item P-1, . . . , P-z. This depiction Abb is evaluated in order to ascertain the delivery address for the mail item.

The first pass ascertains at least the delivery address. It is possible for further parameters to be measured, for example the weight or a dimension of the mail item or with what franking the mail item is provided.

Preferably, the OCR unit OCR-1 in the first sorting installation Anl-1 attempts to ascertain the delivery address automatically by way of optical character recognition (OCR). If this is unsuccessful, a human reads the delivery address and inputs at least one portion of the delivery address, e.g. the ZIP code, into a non-illustrated video encoding station. The sorting installation then transfers the mail item out to one of a plurality of output compartments on the basis of the recognized delivery address.

Mail items which the first sorting installation Anl-1 has transferred out to a particular output compartment Af-1 are placed into a container automatically or manually by way of an installation attendant. This container acts as one of the means of transport. In the example in FIG. 1, this is the first container Beh-1. By placing mail items into the first container Beh-1, the output compartment Af-1 is emptied completely or at least to a large extent. The first container Beh-1 is transported to an intermediate point ZE-2, which is described later.

Preferably, the first container Beh-1 is provided with an identification for said intermediate point ZE-2. This identification is put onto the container preferably in a machine-readable form, on the one hand, and in a form which can be read by humans, on the other hand, for example in the form of a tag.

In one refinement, the sorting installation Anl-1 displays a description of an intermediate point on a display panel in proximity to the output compartment Af-1. The tag is provided with the identification of this displayed destination manually or by a printer.

In another refinement, an electronic tag is used, as is known from the commonly assigned published patent application US 2008/169346 A1 and its counterpart European published patent application EP 1 942 451 A1, for example. This electronic tag has an electronic display panel. Electric power is required only for writing to this display panel, but not for permanently displaying a character string when it has been written to the display panel. A writer in the sorting installation labels this tag.

Once again, the first sorting installation Anl-1 fills the output compartment Af-1. The output compartment Af-1 is again emptied into a container, specifically completely or at least in part. This container may be the same first container Beh-1 or a container other than the one into which the output compartment Af-1 was emptied for the first time.

In the example in FIG. 1, the x mail items P-1, . . . , P-x are moved from the output compartment Af-1 into the first container Beh-1, and the remaining mail items P-y, . . . , P-z are put into the second container Beh-2.

The first container Beh-1 can be reused for a plurality of transportation operations. In the exemplary embodiment, a first transportation operation involves the x mail items P-1, . . . , P-x being transported, and a second transportation operation involves the remaining mail items P-y, . . . , P-z being transported. The remaining mail items P-y, . . . , P-z are put into a further container Beh-2 and are transported in said further container Beh-2 to a further intermediate point. Said further intermediate point may be the same as the one to which the first container Beh-1 was transported, or may be another intermediate point.

In the exemplary embodiment, each intermediate point is a supply device for a sorting installation, for example the supply device ZE-2 of the second sorting installation Anl-2. Such a supply device includes a “feeder” with a singulator.

The container with the mail items is transported to this intermediate point, where it is emptied. The mail items from the first container Beh-1 are supplied to the supply device ZE-2 of the second sorting installation Anl-2. The camera Ka-2 of the second sorting installation Anl-2 again produces a respective computer-accessible depiction of each mail item which passes through the second sorting installation Anl-2. This second sorting installation Anl-2 ascertains the delivery address of each mail item, which the first sorting installation Anl-1 has read as described above. Next, the second sorting installation Anl-2 again transfers each mail item out to one of the output compartments on the basis of the delivery address. The transportation of the mail items to this delivery address is initiated.

In the example in FIG. 1, the mail items P-1, . . . , P-x, P-y, . . . , P-z are transferred out to the output compartment Af-1 of the first sorting installation Anl-1. The mail items P-1, . . . , P-x are then moved from the output compartment Af-1 into the first container Beh-1. The first container Beh-1 with the mail items P-1, . . . , P-x is transported to the supply device ZE-2 of the second sorting installation Anl-2. There, the container Beh-1 is unloaded, and the mail items P-1, . . . , P-x are supplied to the second sorting installation Anl-2 via the supply device ZE-2.

Every possible delivery address has an associated delivery area. All mail items to the same delivery area are transferred out to the same output compartment upon every pass. It is possible for a mail item to pass through the same sorting installation a plurality of times, for example because the number of output compartments is lower than the number of prescribed delivery areas. In this case, “n-pass sequencing” is preferably performed. Such a method is known from U.S. Pat. No. 6,703,574 B1 and its counterpart European patent EP 0 948 416 B1, for example. After the first pass, the mail items which the first sorting installation Anl-1 has transferred out to an output compartment are put into a container. The container is transported to a supply device of the first sorting installation Anl-1, and the mail items are supplied to the first sorting installation Anl-1 for a second pass.

It is also possible for a respective stack of mail items to be transported by means of a conveyor belt from an output compartment back to the supply device of the same sorting installation. It is also possible for a container with mail items which have passed through a sorting installation for the first time to be transported to another location and supplied at said location to the second sorting installation Anl-2.

It is also possible for some mail items to be transported from an output compartment of the second sorting installation Anl-2 in a container to a supply device of a third sorting installation and for said mail items to be supplied to the third sorting installation.

It would very inexpedient if the second sorting installation Anl-2 and every further sorting installation again had to read the delivery address which the first sorting installation Anl-1 has already read, e.g. by means of video encoding.

In the exemplary embodiment, the respective delivery address of a mail item acts as a transportation attribute value for said mail item. Further transportation attribute values may be the weight of the mail item or the value of franking with which the mail item has been provided.

The classic procedure for avoiding this is for the first sorting installation to print coding for the delivery address onto the mail item, e.g. in the form of a bar pattern (bar code). The second sorting installation Anl-2 and every further sorting installation reads this bar pattern.

Frequently, however, it is not wanted for a mail item to be provided with a bar pattern. An agreement by the Universal Postal Union (UPU) provides for cross-border mail items not to be provided with a bar pattern, since different postal service providers normally use different systems of encoding or else similar systems, which would “confuse” a sorting installation.

Therefore, the exemplary embodiment makes use of a method which has become known by the name “fingerprint” or else “virtual ID” and is described in the above-quoted U.S. Pat. No. 6,888,084 B1 and its counterpart European patent EP 1 222 037 B1, and also in U.S. Pat. No. 7,810,712 and its counterpart German patent applications DE 10 2007 057 985 A1 and in DE 10 2008 017 186 A1, for example. This method allows every further sorting installation to ascertain that delivery address which the first sorting installation Anl-1 has read without the need for a bar pattern to be printed.

In the exemplary embodiment, different features of a mail item are prescribed which can be measured externally. Examples of such features are
a dimension of the mail item;
the distribution of grayscale values and/or shades on a surface of the mail item or in a subregion of the surface, e.g. in a quadrant;
the position and dimension of the franking mark on the mail item;
the presence and position of a viewing panel on a mail item;
the position and size of the address block and/or of the block with details of the sender; and
parameters of the delivery address, for example the zip code.

As soon as a mail item Ps passes through the first sorting installation Anl-1, the first camera Ka-1 produces at least one computer-accessible depiction Abb of this mail item Ps. The first evaluation unit Aus-1 produces a feature value vector V for this mail item Ps, for which purpose the first evaluation unit Aus-1 evaluates the depiction Abb of the mail item Ps. To this end, the first sorting installation Anl-1 measures, for the mail item Ps and for each prescribed feature, the respective value which this feature assumes for the mail item Ps. As a result, the first evaluation unit Aus-1 in the first sorting installation Anl-1 produces a feature value vector for this mail item. In the case of N prescribed features, this feature value vector comprises N feature values.

In addition, the first evaluation unit Aus-1 generates a respective computer-accessible identification for each transportation attribute value for the mail item Ps, that is to say particularly an identification for the recognized and deciphered delivery address and possibly for the weight and for a dimension.

The first evaluation unit Aus-1 generates a data record for the mail item Ps, which data record comprises the feature value vector with the N feature values and the respective identification of each transportation attribute value.

In addition, the data record comprises an internal identifier for the mail item. This internal identifier is not printed onto the mail item in the exemplary embodiment, however.

The first container Beh-1 is provided with a first mobile data memory Sp-1. This data memory Sp-1 is permanently connected to the container Beh-1. In the first data memory Sp-1, data can be stored and read again by means of a contact interface or by radio. By way of example, the data memory is in the form of an RFID chip.

The first sorting installation Anl-1 outputs a start signal as soon as the first mail item P-1 reaches the output compartment Af-1. An installation attendant then puts the first container Beh-1 onto a supporting surface. The first sorting installation Anl-1 or else the installation attendant puts the x mail items P-1, . . . , P-x into the first container Beh-1. The first sorting installation Anl-1 then outputs an end signal, and the installation attendant takes the first container Beh-1 from the supporting surface. Between the production of the start signal and the production of the end signal, the first sorting installation Anl-1 transfers exclusively the x mail items P-1, . . . , P-x out to the output compartment Af-1, but no further mail items. As a result, the sorting installation Anl-1 “knows” what mail items are in the first container Beh-1.

The first evaluation unit Aus-1 compiles the x data records for the x mail items P-1, . . . , P-x to form a table or a database. The data memory unit DSE-1 stores this table or database in the mobile data memory Sp-1 of the first container Beh-1.

Preferably, the data memory unit DSE-1 additionally stores an identifier for the first sorting installation Anl-1 and also an identification for the current time, time stamp, in the mobile data memory Sp-1 on the first container Beh-1. This allows the path of the container Beh-1 and the actual transportation times to be reconstructed.

In one embodiment, the first container Beh-1 is placed on the supporting surface such that the data memory Sp-1 on the first container Beh-1 comes into contact with a contact interface of the data memory unit DSE-1. A signal lamp or similar device indicates whether or not the first data memory Sp-1 is actually in a position in which the data memory unit DSE-1 can store data in the data memory Sp-1 via the contact interface. If this is the case, the table or the database is stored in the data memory Sp-1.

In another embodiment, the data memory Sp-1 on the first container Beh-1 is placed in proximity to a transmission device which is part of the data memory unit DSE-1. The transmission device contactlessly transmits the table or the database to the mobile data memory Sp-1.

The first container Beh-1 is transported to the supply device ZE-2 of the second sorting installation Anl-2. The x mail items in this first container Beh-1 are taken from the container Beh-1 and supplied to the supply device ZE-2 of the second sorting installation Anl-2. The x mail items are singularized and pass through the second sorting installation Anl-2. The second camera Ka-2 produces a respective computer-accessible depiction of each mail item P-1, . . . , P-x. The second evaluation unit Aus-2 produces a respective feature value vector V for each mail item by virtue of the second evaluation unit Aus-2 evaluating the depiction from the second camera Ka-2.

This feature value vector V of the mail item Ps is compared with the feature value vectors of data records in the table or the database which are stored in the mobile data memory Sp-1 of the first container Beh-1. A respective degree of match between the feature value vector V of the mail item Ps and a stored feature value vector V is calculated. That stored feature value vector which delivers the greatest degree of match is ascertained and selected. This finds that data record which was produced when the mail item passed through the first sorting installation Anl-1 and which comes from the same mail item Ps. The second sorting installation Anl-2 and every further sorting installation use the delivery address and the further transportation attribute values of this data record for transporting this mail item.

For the purpose of reading, the data memory Sp-1 is placed in proximity to the reader LG-2 of the second sorting installation Anl-2. The reader LG-2 reads in the data records which are stored in the data memory Sp-1.

Preferably, these data records are at least temporarily stored in a data memory of the second sorting installation Anl-2 in order to be able to quickly search for the correct feature value vector. The reader LG-2 reads in the data from the mobile data memory Sp-1 either via a contact interface or contactlessly.

The steps just described are now performed for the further mail items P-y, . . . , P-z in a corresponding manner. The first sorting installation Anl-1 has transferred these further (z−y+1) mail items out to the output compartment Af-1 after the x mail items p-1, . . . , p-y. The first evaluation unit Aus-1 has produced a respective data record for each mail item, and this data record is stored. The mail items P-y, . . . , P-z are placed into a further container Beh-2 and moved to the supply device ZE-2 of the second sorting installation Anl-2 or to a supply device ZE-3 of a third sorting installation. Again, a feature value vector is produced for each mail item and is compared among stored feature value vectors. The transportation attribute values of these ascertained data records are used for further transportation.

In one embodiment, the second container Beh-2 is likewise connected to a mobile data memory, namely to the data memory Sp-2. The data memory device DSE-1 stores the data records for the mail items P-y, . . . , P-z in the mobile data memory Sp-2, and the reader LG-2—or a reader of the third sorting installation—reads in the data records from the second data memory Sp-2.

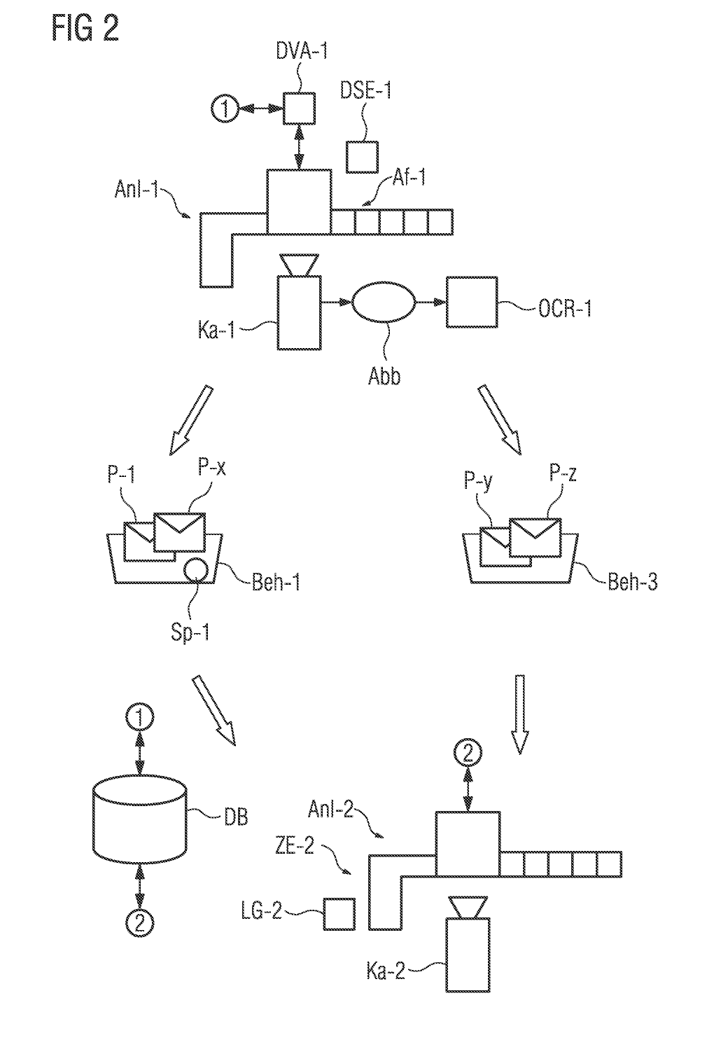

FIG. 2 shows an alternative embodiment. The embodiment of FIG. 2 allows containers with and containers without a mobile data memory to be used simultaneously. In this alternative embodiment, both the first sorting installation Anl-1 and the second sorting installation Anl-2 are connected to a central and immovable database DB. The data memory device DSE-1 or a further data processing installation DVA-1 of the first sorting installation Anl-1 stores the data records for the z mail items P-1, . . . , P-x, P-y, . . . , P-z additionally in the central database DB.

The alternative embodiment is explained with reference to the example in which the first container Beh-1 has a mobile data memory Sp-1, but a third container Beh-3 has no data memory. Preferably, the third container Beh-3 has a different color or another differing marking than the first container Beh-1, so that it is immediately possible to tell that only the first container Beh-1 has a mobile data memory.

The first container Beh-1 is placed onto the supporting surface of the output compartment Af-1 in a position such that the data memory unit DSE-1 can store the x data records of the mail items P-1, . . . , P-x in the mobile data memory Sp-1. The third container Beh-3 needs to be placed onto the supporting surface only such that the remaining (z−y+1) mail items can easily be placed into the third container Beh-3.

When a container has been placed onto the supporting surface and in proximity to the data memory unit DSE-1, it is automatically checked whether or not said container has a mobile data memory which can now be read. If the third container Beh-3 is placed onto the supporting surface, the first sorting installation Anl-1 automatically establishes that said third container Beh-3 has no mobile data memory. The data memory device DSE-1 or the further data processing installation DVA-1 then stores the data records for the (z−y+1) mail items which are transported in the third container Beh-3 in the central database DB.

When the first container Beh-1 has been transported to the second sorting installation Anl-2, each of the x mail items P-1, . . . , P-x from the first container Beh-1 has a search performed for the data record of said mail item by virtue of the data records which are stored in the data memory Sp-1 being searched. When the third container Beh-3 has been transported to the second sorting installation Anl-2 or to the third sorting installation, each of the (z−y+1) mail items P-y, . . . , P-z from the third container Beh-3 has a search performed for the data record for said mail item. This involves searching data records which are stored in the central database DB. It is possible to restrict the search space for this search, for example as described in U.S. Pat. No. 6,888,084 B1 and its counterpart European patent EP 1 222 037 B1, and also in U.S. Pat. No. 7,810,712 and its counterpart German patent applications DE 10 2007 057 985 A1 and in DE 10 2008 017 186 A1.

In a development of this refinement, at least one of the x mail items from the first container Beh-1 also has a search performed for the appropriate data record in the central database DB. The initial situation is again the one in which the second camera Ka-2 has produced a depiction of a mail item Ps while this mail item Ps passes through the second sorting installation Anl-2. The second evaluation unit Aus-2 has produced a feature value vector by evaluating the depiction of the mail item Ps. What needs to be ascertained in that data record which comes from this mail item Ps. This is done by first of all comparing the feature value vector with the feature value vectors of those data records which are stored in the mobile data memory Sp-1 of the first container Beh-1. In one refinement, the feature value vector is compared with feature value vectors from data records in the central database DB anyway.

In another refinement, the feature value vector is compared with feature value vectors from data records in the central database DB at least when the reader (LG-2) cannot read in the content of the data memory Sp-1.

In a third refinement, a respective degree of match between the feature value vector from the mail item Ps and of each feature value vector of a data record in the mobile data memory Sp-1 is calculated. If this degree of match is below a prescribed limit, the feature value vector from the mail item Ps is additionally compared with feature value vectors from data records in the central database DB. If the degree of match is greater than or equal to the limit, this comparison with data records in the central database DB does not take place. In the first case, that data record for which the feature value vector has the highest degree of match is ascertained. This refinement avoids errors for the situation in which the first container Beh-1 contains additional mail items for which no data record has been stored in the data memory Sp-1.

1. A method for transporting articles, wherein at least one measurable transportation attribute and at least one measurable feature are prescribed, and the method comprises:
for each article,
taking a measurement to ascertain what value the measurable feature assumes for the respective article;
taking a measurement to ascertain what value the measurable transportation attribute assumes for the respective article; and
producing and storing a data record for the article, the data record containing:
the at least one measured transportation attribute value; and
the at least one measured feature value;
providing a means of transport with a data memory to be transported together with the means of transport,
placing the article into the means of transport and transporting the article to an intermediate point with the at least one means of transport and the data memory, wherein the respective data record for the article is stored in the data memory; and
following transportation to the intermediate point, for each article which is transported using the means of transport:
taking a further measurement to ascertain what value the feature assumes for the article;
ascertaining the data record for the respective article from the data records stored in the data memory of the means of transport; and
initiating further transportation of the article based on the transportation attribute value contained in the data record thus ascertained.

2. The method according to claim 1, which comprises, for at least one article which is transported using one of the means of transport,
storing the data record for the article in a stationary data memory; and
searching the data record for this article involves searching among data records which are stored in the immovable data memory.

3. The method according to claim 2, wherein the means of transport is one of a plurality of means of transport are used, and
following the transportation of one of the means of transport to the intermediate point, automatically performing a check to determine whether or not the respective means of transport has a data memory;
if the means of transport has a data memory, ascertaining the data record among the data records stored in the data memory; and
if the means of transport does not have a data memory, seeking the data record among data records that are stored in the stationary data memory.

4. The method according to claims 1, which comprises:
locking the data memory of the at least one means of transport against alteration of the stored data after the articles have been put into the means of transport and the data records for these articles have been stored in the data memory; and
lifting the lock no earlier than when the means of transport with the articles reaches the intermediate point.

5. The method according to claim 1, wherein the step of measuring what value the at least one feature assumes for the article comprises producing and evaluating a computer-accessible depiction of the article.

6. The method according to claim 1, which comprises:
measuring the feature value and the transportation attribute value of each article prior to a placement of the article into the at least one means of transport, and
initiating, with the step of putting the articles into the means of transport, the step of storing the data records for these articles in the data memory of the means of transport.

7. The method according to claim 1, wherein a plurality of measurable features are prescribed, and the method further comprises:
for each article and for each prescribed feature, including in the measurement and the further measurement a respective feature value; and
producing a respective feature value vector which distinguishes this article from the other transported articles.

8. An apparatus for the transportation of articles, comprising:
a first measuring instrument configured to measure, for each article, a respective value which at least one prescribed feature assumes for the article;
an attribute measuring instrument configured to measure, for each article, what value at least one prescribed transportation attribute assumes for the article;
at least one means of transport configured to receive the articles therein and to transport the articles in the at least one means of transport to an intermediate point, said at least one means of transport carrying a data memory during transportation of the articles;
a first data processing device configured to produce and store, for each article, a respective data record containing:
the at least one measured transportation attribute value; and
the at least one measured feature value;
said first data processing device being configured to store, for each article, the respective data record in said data memory of said means of transport; and
a second measuring instrument configured to carry out a further measurement measuring again, for each article, a respective value which the prescribed feature assumes for this article, said second measuring instrument being disposed to measure the value following transportation of the article to the intermediate point; and
a second data processing device configured to use the feature value measured during the further measurement to ascertain the data record produced and stored for this article; and
said second data processing device ascertaining, for each article, the respective data record from the data records stored in said data memory of the means of transport; and
said second data processing device initiating further transportation of each article on the basis of the transportation attribute value thereof that is contained in the data record thus ascertained.

9. The apparatus according to claim 8, which further comprises:
a stationary data memory; and
a further data processing installation configured to store the data records for the articles additionally in said stationary data memory; and
wherein the apparatus is configured to search for at least one article which is transported using one of the means of transport when the data record for this article is ascertained additionally among data records which are stored in said stationary data memory.

10. The apparatus according to claim 9, which further comprises at least one further means of transport, and wherein the apparatus is configured:
to check whether or not a given means of transport used for the transportation of the articles has a data memory; and
if the given means of transport does not have a data memory, to store the data records for the articles that are transported in the given means of transport in said stationary data memory.
